(19) United States
(12) Patent Application Publication
(10) Pub. No.: US 2006/0114216 A1
(43) Pub. Date: Jun. 1, 2006

(54) Gate line driver circuits for LCD displays

(76) Inventor: Yeon-tack Shim, Gyeonggi-do (KR)

Correspondence Address: MYERS BIGEL SIBLEY & SAJOVEC, PO BOX 37428, RALEIGH, NC, 27627, US

(21) Appl. No.: 11/135,246

(22) Filed: May 23, 2005

(30) Foreign Application Priority Data
Nov. 6, 2004 (KR) 2004-90142

(51) Int. Cl. G09G 3/36

(52) U.S. Cl. 345/100

(57) ABSTRACT

A liquid crystal display (LCD) includes an LCD panel having a plurality of rows of pixel elements therein and a corresponding plurality of gate lines coupled to the plurality of rows of pixel elements. A gate line driver is also provided. The gate line driver is electrically coupled to the plurality of gate lines by a corresponding plurality of fan-out lines having unequal lengths and unequal resistance values. The gate line driver includes at least first and second buffers coupled to first and second ones of the plurality of fan-out lines, respectively. The first and second buffers having unequal pull-up impedances that inversely compensate for the unequal resistance values of the first and second ones of the plurality of fan-out lines.

### REFERENCE TO PRIORITY APPLICATION

This application claims priority to Korean Patent Application No. 2004-90142, filed Nov. 6, 2004, the disclosure of which is hereby incorporated herein by reference.

### FIELD OF THE INVENTION

The present invention relates to display devices and, more particularly, to liquid crystal display (LCD) devices.

### BACKGROUND OF THE INVENTION

FIG. 1 is a schematic block diagram of a conventional liquid crystal display (LCD) device 10. The LCD device 10 includes an LCD panel 11, source driver integrated circuits 12, and gate driver integrated circuits 13. On the LCD panel 11, pixels (not shown) using thin film transistors (TFTs) as switching devices are arranged in a matrix form with a plurality of rows and columns. The gates of the TFTs in the pixels are connected to gate lines (not shown) formed on the LCD panel 11. In addition, the source driver integrated circuits 12 are arranged along a column direction of the LCD panel 11, and the gate driver integrated circuits 13 are arranged along a row direction of the LCD panel 11. Referring to the highlighted portion of the gate driver integrated circuit 13 identified by the reference character “A” in FIG. 1, output terminals (not shown) of the gate driver integrated circuit 13 are connected to circuit patterns formed on a flexible film 14. The flexible film 14 is attached to the LCD panel 11 by an adhesive material 15. The circuit patterns formed on the flexible film 14 are connected to circuit patterns formed on the LCD panel 11. Fan-out lines 16 connecting the output terminals of the gate driver integrated circuit 13 and the gate lines (not shown) on the LCD panel 11 are formed using circuit patterns of the flexible film 14 and circuit patterns of the LCD panel 11.

Referring to FIG. 1, lengths of the fan-out lines 16 are different from each other according to the different pattern shapes of the lines 16. Because the lengths of the fan-out lines 16 are different from each other, the resistance values of the fan-out lines 16 are also different from each other (assuming uniform line widths). FIG. 2 shows the gate driver integrated circuit 13, and equivalent circuits of the fan-out lines 16a and 16b and gate lines 17a and 17b shown in FIG. 1. The gate line 17a is disposed at the outermost portion (e.g., top) of the LCD panel 11, and the gate line 17b is disposed at the center of the LCD panel 11. The fan-out line 16a connects the gate driver integrated circuit (IC) 13 and the gate line 17a, and the fan-out line 16b connects the gate driving IC 13 and the gate line 17b. In FIG. 2, the elements Ro1 and Co1 denote resistance and capacitance of the fan-out line 16a, and the elements RoN and CoN (N is an integer) denote resistance and capacitance of the fan-out line 16b. In addition, the elements R1, R2, and R3 denote the resistance values of pixels connected to the gate lines 17a and 17b equivalently, and the elements C1, C2, and C3 denote equivalent capacitance values of the pixels connected to the gate lines 17a and 17b. Thus, each gate line may be treated as a distributed RC network.

Here, since the length of the fan-out line 16b located at the center of the panel 11 is the shortest, the value of resistance RoN is the smallest, and since the length of the fan-out line 16a is the longest, the value of the resistance Ro1 is the largest. Therefore, a resistance difference of hundreds of ohms may be generated between the resistances Ro1 and RoN. Gate control signals GS1 and GSN (N is an integer) transmitted to the gate lines 17a and 17b through the fan-out lines 16a and 16b are delayed differently from each other due to the difference in the resistance values of the fan-out lines 16a and 16b. Consequently, the image around the gate line 17b that is connected to the fan-out line 16b at the center of the panel 11 may be relatively bright, and the image around the gate line 17a connected to the fan-out line 16b near a top of the panel 11 may be relatively dark. As shown in FIG. 1, this brightness difference may appear as horizontal stripes on the LCD panel 11.

FIG. 3A is a waveform diagram of the gate control signals shown in FIG. 2. In FIG. 3A, GSI′ and GSN′ are waveforms of the gate control signals GS1 and GSN at nodes ND1, when the gate control signals GS1 and GSN passing through the fan-out lines 16a and 16b are input into the nodes ND1, (i.e., at starting points of the gate lines 17a and 17b). In addition, GS1″ and GSN″ are waveforms of the gate control signals GS1 and GSN at nodes ND2, (i.e., at end points of the gate lines 17a and 17b). Referring to FIG. 3A, phases of the GSN′ and GSN″ are faster than those of the GS1′ and GS1″. That is, the gate control signal GSN can transmit along the fan-out line 16b at the center of the panel 11, which has a smaller resistance value, faster than the gate control signal GS1 that passes through the fan-out line 16a near the edge of the panel 11. FIG. 3B is a timing view of the gate control signals shown in FIG. 2. The time intervals T1 and T2 represent the unequal durations of the enable states of the gate control signals GS1′ and GSN′. Rising edges of the gate control signals GS1′ and GSN′ exist at different points from each other and result in a rising edge difference of ΔT. Therefore, the turn-on time of the TFTs connected to the gate lines 17b are longer than that of the TFTs connected to the gate line 17a. Accordingly, the quality of an image displayed on the LCD panel 11 may be relatively poor.

### SUMMARY OF THE INVENTION

A liquid crystal display (LCD) according to some embodiments of the present invention includes an LCD panel having a plurality of rows of pixel elements therein and a corresponding plurality of gate lines coupled to the plurality of rows of pixel elements. A gate line driver is also provided. The gate line driver is electrically coupled to the plurality of gate lines by a corresponding plurality of fan-out lines having unequal lengths and unequal resistance values. The gate line driver includes at least first and second buffers coupled to first and second ones of the plurality of fan-out lines, respectively. The first and second buffers have unequal pull-up impedances that inversely compensate for the unequal resistance values of the first and second ones of the plurality of fan-out lines.

Additional embodiments of the invention include a gate line driver circuit for a liquid crystal display (LCD). This gate line driver circuit includes at least a first buffer and a second buffer. The first buffer is configured to provide a first pull-up resistance (e.g., PMOS on-state channel resistance) to a first fan-out line having a first line resistance, when driving the first fan-out line with a leading edge of a first gate signal pulse. The second buffer is configured to provide a second pull-up resistance to a second fan-out line having a second line resistance, when driving the second fan-out line with a leading edge of a second gate signal pulse. The first and second line resistances are unequal by virtue of the fact that the first and second fan-out lines have unequal lengths. To maintain a high degree of timing overlap between the first and second leading edges of the first and second gate pulses, a sum of the first pull-up resistance and the first line resistance equals a sum of the second pull-up resistance and the second line resistance. Moreover, to maintain a high degree of timing overlap between first and second trailing edges of the first and second gate pulses, the first buffer is further configured to provide a first pull-down resistance (e.g., NMOS on-state channel resistance) to the first fan-out line, when driving the first fan-out line with the trailing edge of the first gate signal pulse. The first buffer is configured so that a sum of the first pull-down resistance and the first line resistance equals a sum of the second pull-up resistance and the second line resistance.

### BRIEF DESCRIPTION OF THE DRAWINGS

FIG. 1 is a plan view of a liquid crystal display (LCD) device according to the prior art.

FIG. 2 is an electrical schematic of a gate line driver circuit illustrated by FIG. 1, which is coupled to a plurality of fan-out lines and gate lines.

FIG. 3A is a timing diagram that illustrates the timing of a plurality of gate signals that traverse the gate lines illustrated by FIG. 2.

FIG. 3B is a timing diagram that illustrates consecutive rising and falling edges of the gate signals GS1′ and GSN′ at nodes ND1 in FIG. 2.

FIG. 4 is a block diagram of a gate line driver according to embodiments of the present invention.

FIG. 5 is an electrical schematic of a plurality of gate line driver buffers and gate lines, according to embodiments of the present invention.

FIG. 6A is a timing diagram that illustrates the timing of a plurality of gate signals that traverse the gate lines illustrated by FIG. 5.

FIG. 6B is a timing diagram that illustrates consecutive rising and falling edges of the gate signals G1′, G(M/2)′ and GM′ at nodes ND1 in FIG. 5.

### DETAILED DESCRIPTION OF EMBODIMENTS OF THE INVENTION

The present invention now will be described more fully herein with reference to the accompanying drawings, in which preferred embodiments of the invention are shown. This invention may, however, be embodied in many different forms and should not be construed as being limited to the embodiments set forth herein; rather, these embodiments are provided so that this disclosure will be thorough and complete, and will fully convey the scope of the invention to those skilled in the art. Like reference numerals refer to like elements throughout and signal lines and signals thereon may be referred to by the same reference characters. Signals may also be synchronized and/or undergo minor boolean operations (e.g., inversion) without being considered different signals. The suffix B (or prefix symbol “/”) to a signal name may also denote a complementary data or information signal or an active low control signal, for example.

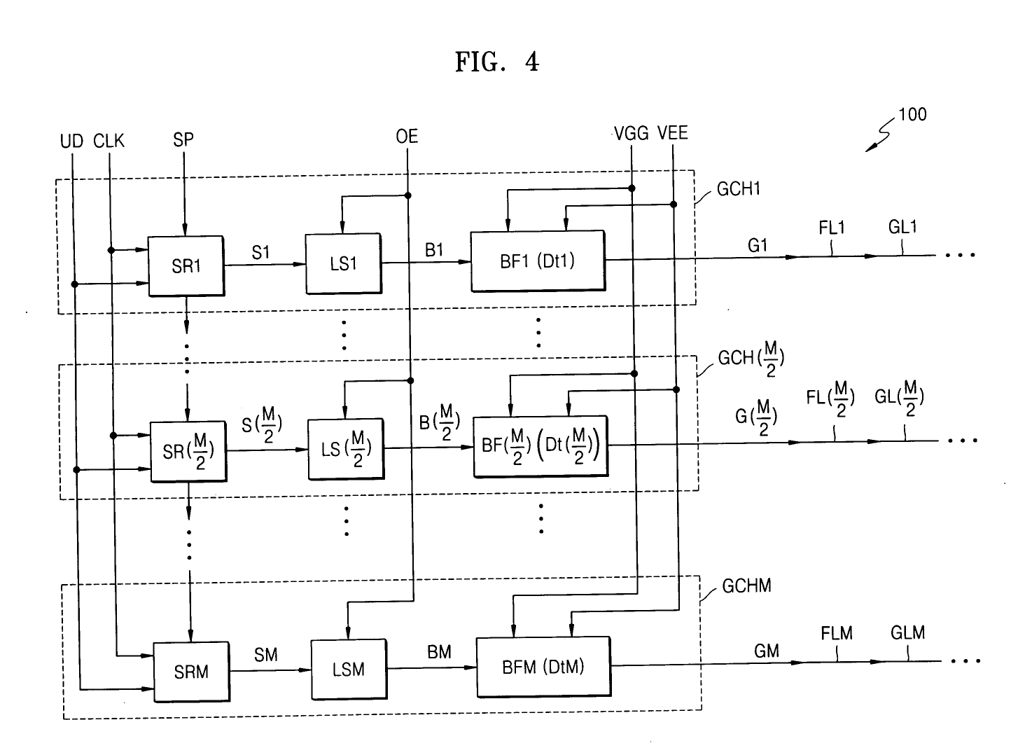

FIG. 4 is a block diagram of a gate driver integrated circuit 100 for a liquid crystal display (LCD) according to an embodiment of the present invention. The gate driver integrated circuit 100 includes a plurality of gate channel circuits GCH1˜GCHM (where, M is an even integer). The plural gate channel circuits GCH1˜GCHM are arranged in parallel to each other, and connected to gate lines GL1˜GLM through fan-out lines FL1˜FLM, respectively. In FIG. 4, the gate channel circuits GCH1, GCH(M/2), and GCHM represent circuits along the top, middle and bottom portions of the display. Structures and operations of the gate channel circuits GCH2˜GCH((M/2)−1), GCH((M/2)+1)˜GCH(M−1) are similar to those of the gate channel circuits GCH1, GCH(M/2), and GCHM.

The gate circuit channel GCH1 includes a shift register SR1, a level shifter LS1, and an output buffer BF1, and the gate channel circuit GCH(M/2) includes a shift register SR(M/2), a level shifter LS(M/2), and an output buffer BF(M/2). In addition, the gate channel circuit GCHM includes a shift register SRM, a level shifter LSM, and an output buffer BFM. The shift register SR1 receives a start pulse signal SP and outputs a shift signal S1 in response to a clock signal CLK and a shift direction selection signal UD. In addition, the shift register SR1 outputs the start pulse signal SP to a shift register SR2 of the next gate channel circuit GCH2. The shift register SR(M/2) receives the start pulse signal SP from the shift register SR((M/2)−1) of the gate channel circuit GCH((M/2)−1) and outputs the shift signal S(M/2) in response to the clock signal CLK and the direction selection signal UC. The shift register SRM receives the start pulse signal SP from the shift register SR(M−1) of the gate channel circuit GCH(M−1) and outputs the shift signal SM in response to the clock signal CLK and the direction selection signal UD. In addition, the shift register SRM outputs the start pulse signal SP to the shift register of the first gate channel circuit in the next gate driver integrated circuit (not shown). Here, the start pulse signal SP can be transmitted sequentially from the shift register SR1 to the shift register SRM or transmitted from the shift register SRM to the shift register SR1 according to the direction selection signal UD.

The level shifters LS1, LS(M/2), and LSM convert voltages levels of the shift signals S1, S(M/2), and SM into the levels that support control of the output buffers BF1, BF(M/2), and output the converted signals as buffer control signals B1, B(M/2), and BM. Here, the outputs of the level shifters LS1˜LSM can be controlled by an output enable masking signal OE. The output buffer BF1 outputs a gate control signal G1 in response to the buffer control signal B1. Here, the output buffer BF1 delays the gate control signal G1 for a predetermined delay time Dt1, and outputs the gate control signal G1. The output buffer BF(M/2) outputs a gate control signal G(M/2) in response to the buffer control signal B(M/2). The output buffer BF(M/2) delays the gate control signal G(M/2) for a predetermined delay time Dt(M/2) and outputs the gate control signal G(M/2). Here, the delayed times Dt1 and Dt(M/2) are set differently from the delay time DtM. In particular, the delay time Dt(M/2) is set to be longer than the delay times Dt1 and DtM.

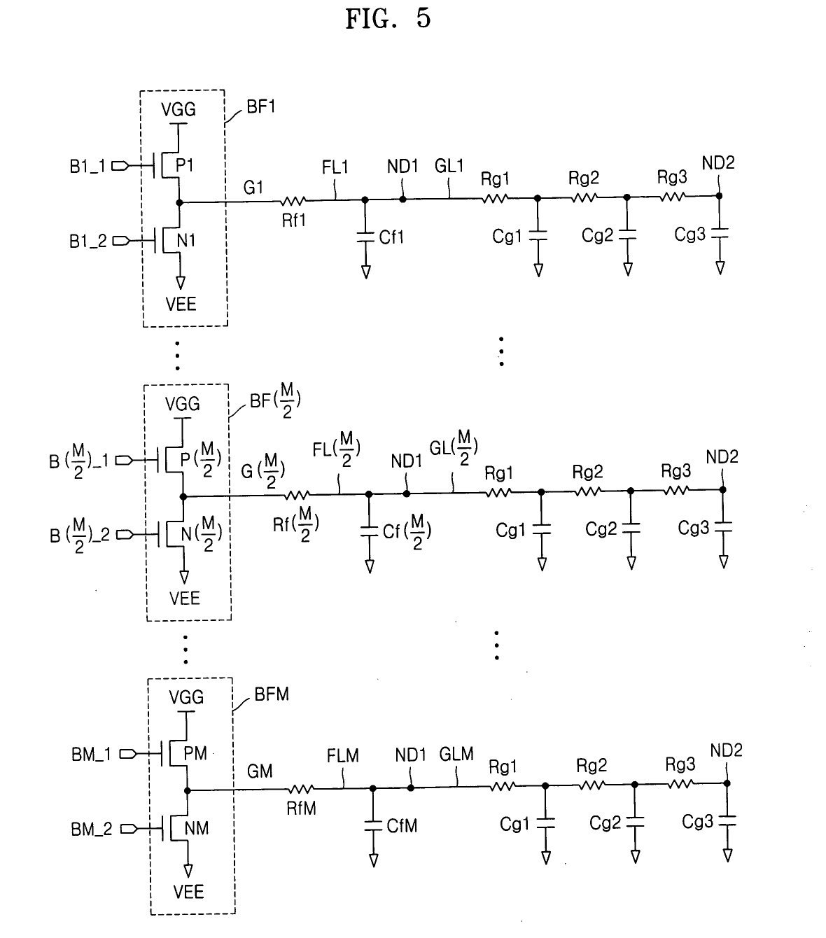

Referring to FIG. 5, operations of the output buffers BF1, BF(M/2), and BFM will be described in more detail. FIG. 5 is a view of the output buffers BF1, BF(M/2), and BFM shown in FIG. 4, and equivalent circuits of the fan-out lines FL1, FL(M/2), and FLM and the gate lines GL1, GL(M/2), and GLM. In FIG. 5, Rf1, Rf(M/2), and RfM are resistance values of the fan-out lines FL1, FL(M/2), and FLM, and Cf1, Cf(M/2), and CfM are capacitance values of the fan-out lines FL1, FL(M12), and FLM. In addition, Rg1, Rg2, and Rg3 are equivalent values of the entire resistance values of pixels connected to the gate lines GL1, GL(M/2), and GLM, and Cg1, Cg2, and Cg3 are equivalent values of entire capacitance value of the pixels connected to the gate lines GL1, GL(M/2), and GLM.

Here, since a length of the fan-out line FL(M/2) located at a center of the LCD display panel is the shortest, the resistance value Rf(M/2) is the smallest, and since the lengths of the fan-out lines FL1 and FLM are the longest, the resistance values Rf1 and RfM are the largest. In addition, among the resistance values Rf1˜RfM of the fan-out lines FL1˜FLM, the resistance values increase gradually in directions away from the center fan-out line FL(M/2). Therefore, the resistance values Rf((M/2)−1)˜Rf1 and the resistance values Rf((M/2)+1)˜RfM are symmetric with each other relative to the center fan-out line FL(M/2).

The output buffers BF1, BF(M/2), and BFM respectively include PMOS transistors P1, P(M/2), and PM and NMOS transistors N1, N(M/2), and NM, and voltages VGG and VEE are applied to the output buffers as driving voltages. Gate control signals B1_1, B(M/2)_1, and BM_1 are input to the gates of the PMOS transistors P1, P(M/2), and PM, and gate control signals B1_2, B(M/2)_2, and BM_2 are input to the gates of the NMOS transistors N1, N(M/2), and NM. The gate control signal B1 can be simultaneously input into the gates of the PMOS transistor P1 and the NMOS transistor N1, the gate control signal B(M/2) can be simultaneously input into the gates of the PMOS transistor P(M12) and the NMOS transistor N(M/2), and the gate control signal BM can be simultaneously input into the gates of the PMOS transistor PM and the NMOS transistor NM.

In addition, the delay times Dt1, Dt(M/2), and DtM of the output buffers BF1, BF(M/2), and BFM are set to be in inverse-proportion to the resistance values Rf1, Rf(M/2), and RfM of the fan-out lines FL1, FL(M/2), and FLM, and the delay times Dt1, Dt(M/2), and DtM are in inverse-proportion to current driving capacities of the output buffers BF1, BF(M/2), and BFM. For example, when the current driving capacity of the output buffer BF1 increases, the delay time Dt1 is reduced. More desirably, the delay times Dt1˜DtM are set at different values to compensate for the different resistance values of the fan-out lines FL1-FLM. In addition, the current driving capacities of the output buffers BF1, BF(M/2), and BFM are in inverse-proportion to the resistance values of the output buffers BF1, BF(M/2), and BFM. Therefore, the resistance value of the output buffer BF(M/2) is the largest, and the resistance value is reduced in the directions of the output buffers BF1 and BFM from the output buffer BF(M/2). Therefore, a sum of the resistance values of the output buffers BF1, BF(M/2), and BFM and a sum of the resistance values Rf1, Rf(M/2), and RfM of the corresponding fan-out lines FL1, FL(M/2), and FLM are the same as each other. For example, when the resistance values Rf1, Rf(M/2), and RfM are 650 Ω, 180 Ω, and 650 Ω, the resistance values of the output buffers BF1, BF(M/2), and BFM can be set as 200 Ω, 670 Ω, and 200 Ω. In other words, the pull-up resistance values of PMOS transistors P1, P(M/2) and PM are 200, 670 and 200 ohms, respectively, and the pull-down resistance values of NMOS transistors N(M/2) and NM are 200, 670 and 200 ohm, respectively. In addition, when the resistance values of the output buffers are gradually reduced from the middle buffer BF(M/2), the reduced amount ΔR can be calculated by following equation.

$$Δ R = \frac{[ {R}_{f} 1 - {R}_{f} ( \frac{M}{2} ) ] ⨯ 2}{M} ( M is the number of gate channels ) \qquad ( 1 )$$

Thus, the resistance value is reduced in ΔR units in the directions to the output buffers BF1 and BFM from the output buffer BF(M/2). Consequently, the difference between the resistance values of the neighboring two output buffers in the gate channel is ΔR. In addition, relations between the resistance values of the output buffers BF1˜BFm and the resistance values of the fan-out lines FL1˜FLM can be represented as shown in Table 1.

TABLE 1

| | | | Sum of resistance |
|---|---|---|---|
| | Resistance | | values of fan-out |
| | values of | Resistance values | lines and sum of |
| Gate | fan-out lines | of output buffers | resistance values of |
| channels | (FL1˜FLM) | (BF1˜BFM) | output buffers |
| GCH1 | Rf1 | C | Rf1 + C |
| GCH2 | Rf1 − ΔR | C + ΔR | Rf1 + C |
| GCH3 | Rf1 − 2ΔR | C + 2ΔR | Rf1 + C |
| . | . | . | . |
| . | . | . | . |
| . | . | . | . |
| GCH(M/2) | Rf(M/2) | C + β | Rf1 + C |
| | (=Rf1 − β) | | |
| . | . | . | . |
| . | . | . | . |
| . | . | . | . |
| GCH(M − 2) | Rf1 − 2ΔR | C + 2ΔR | Rf1 + C |
| GCH(M − 1) | Rf1 − ΔR | C + ΔR | Rf1 + C |
| GCHM | RfM(=Rf1) | C | Rf1 + C |

β = Rf1 − Rf(M/2)

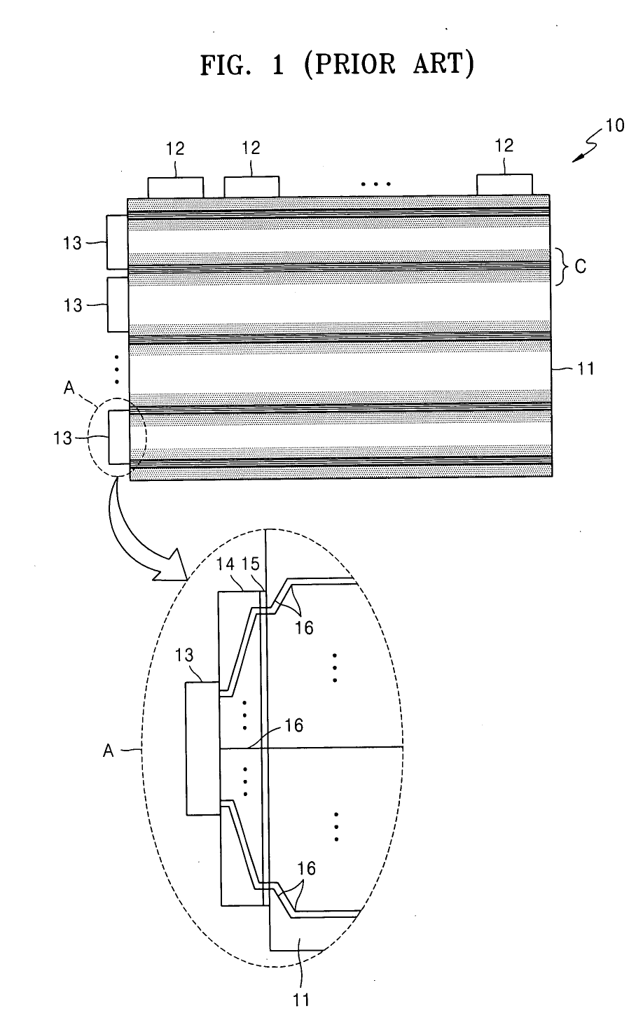

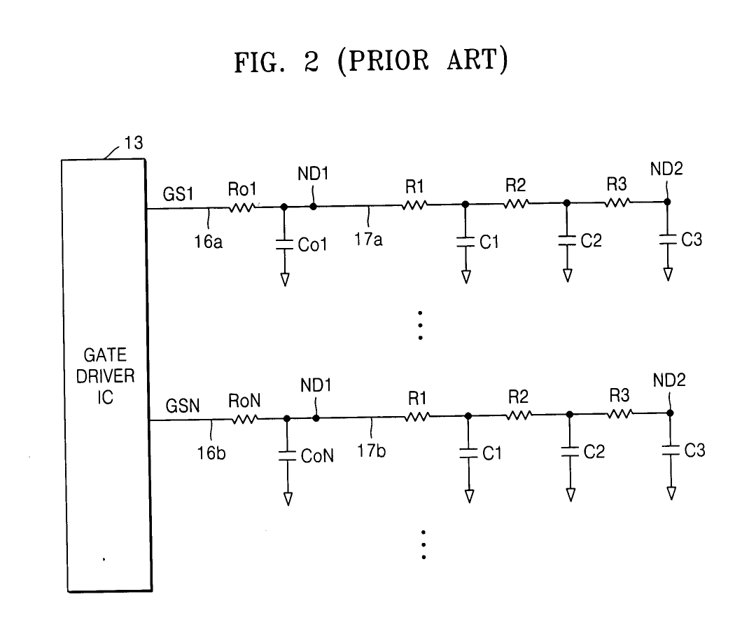

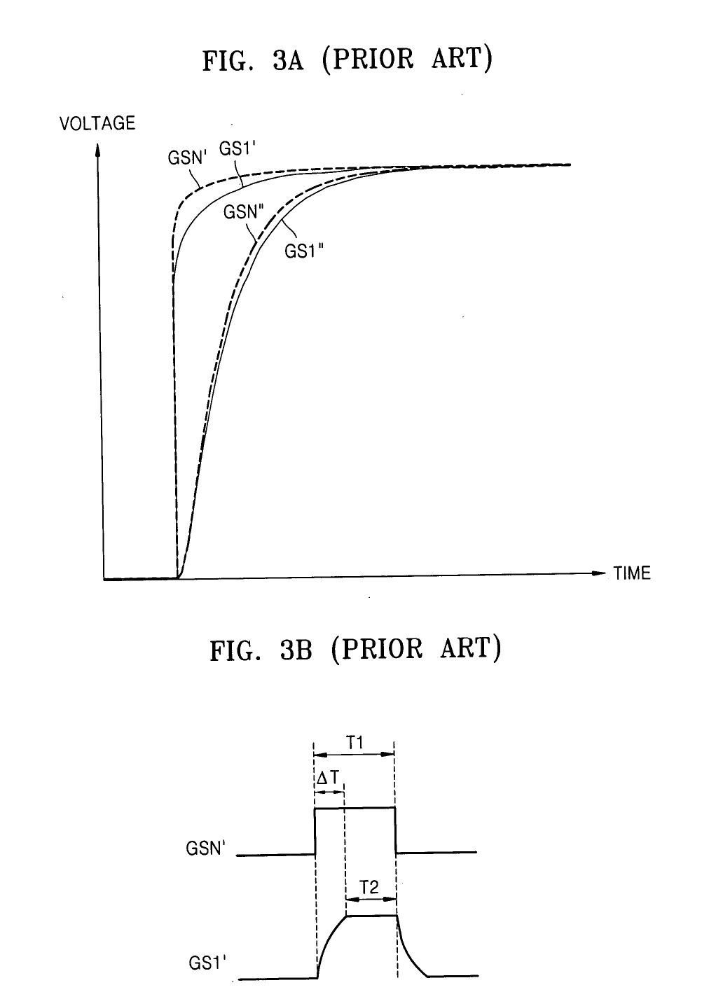

As described above, when the resistance values of the output buffers BF1˜BFM are set to be in the inverse-proportion to the resistance values Rf1˜RfM of the fan-out lines FL1˜FLM, times taken by the gate control signals G1˜GM output from the output buffers BF1˜BFM to pass through the fan-out lines FL1˜FLM become more nearly the same. Therefore, defects such as the stripes (C) in FIG. 1 can be prevented.

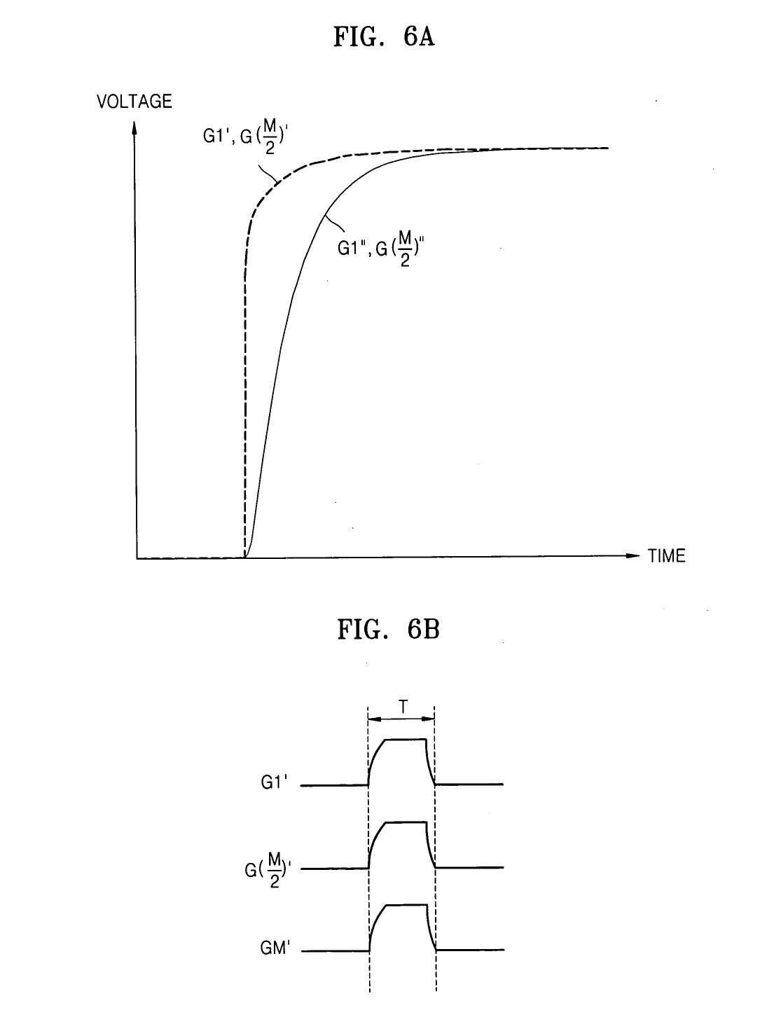

FIG. 6A is a waveform diagram of the gate control signals shown in FIG. 5. Referring to FIG. 6A, curves G1′ and G(M/2)′ are waveforms of the gate control signals G1 and G(M/2) at nodes ND1, when the gate control signals G1 and G(M/2) that traverse the fan-out lines FL1 and FL(M/2) are input into the nodes ND1, that is, the starting points of the gate lines GL1 and GL(M/2). In addition, curves G1″ and G(M/2)″ are waveforms of the gate control signals G1 and G(M/2) at nodes ND2, that is, the ending points of the gate lines GL1 and GL(M/2). In FIG. 6A, phases of G1′ and G(M/2)′ are the same as each other, and phases of G1″ and G(M/2)″ are also the same as each other. Thus, as illustrated by FIG. 6A, the time taken by the gate control signal G1 to pass through the fan-out line FL1 is the same as that taken by the gate control signal G(M/2) to pass through the fan-out line FL(M/2).

FIG. 6B is a timing view of the gate control signals shown in FIG. 5 comparing the times of maintaining the enabled states of the gate control signals G1′, G(M/2)′, and GM′. Referring to FIG. 6B, the enabled periods of the gate control signals G1′, G(M/2)′, and GM′ are the same as each other, that is, T. Therefore, the turn-on times of TFTs connected to the gate lines GL1, GL(M/2), and GLM are the same as each other, which means the quality of the image displayed on the LCD panel can be improved.

In addition, since the gate driver integrated circuit for the LCD according to the present invention does not use an additional circuit, but controls the resistance values of the output buffers so that the resistance values of the output buffers are in the inverse-proportion to the resistances of the fan-out lines in order to compensate the resistance difference between the fan-out lines, a size of the chip is not increased. In addition, the current driving capacity of the output buffer can be reduced gradually toward the output buffer at the center from the outer portion, and thus the power consumption can be reduced.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A liquid crystal display (LCD), comprising:
an LCD panel having a plurality of rows of pixel elements therein and a corresponding plurality of gate lines coupled to the plurality of rows of pixel elements; and
a gate line driver electrically coupled to the plurality of gate lines by a corresponding plurality of fan-out lines having unequal lengths and unequal resistance values, said gate line driver comprising at least first and second buffers coupled to first and second ones of the plurality of fan-out lines, respectively, said first and second buffers having unequal pull-up impedances that inversely compensate for the unequal resistance values of the first and second ones of the plurality of fan-out lines.

2. The display of claim 1, wherein said first and second buffers have unequal pull-down impedances that inversely compensate for the unequal resistance values of the first and second ones of the plurality of fan-out lines.

3. The display of claim 2, wherein said first buffer comprises a first PMOS transistor having a drain electrically connected to the first one of the plurality of fan-out lines and a first NMOS transistor having a drain electrically connected to the first one of the plurality of fan-out lines.

4. The display of claim 1, further comprising a first level shifter having an output electrically coupled to an input of the first buffer, said first level shifter responsive to an output enable signal.

5. The display of claim 4, further comprising a first shift register responsive to a start pulse signal and a clock signal, said first shift register having an output electrically coupled to an input of said first level shifter.

6. The display of claim 5, further comprising:
a second level shifter having an output electrically coupled to an input of the second buffer, said second level shifter responsive to the output enable signal; and
a second shift register responsive to the clock signal, said second shift register having an input electrically coupled to an output of said first shift register and an output electrically coupled to an input of said second level shifter.

7. A gate line driver circuit for a liquid crystal display (LCD), comprising:
a first buffer configured to provide a first pull-up resistance to a first fan-out line having a first line resistance when driving the first fan-out line with a leading edge of a first gate signal pulse; and
a second buffer configured to provide a second pull-up resistance to a second fan-out line having a second line resistance when driving the second fan-out line with a leading edge of a second gate signal pulse;
wherein the first and second line resistances are unequal by virtue of the fact that the first and second fan-out lines have unequal lengths; and
wherein a sum of the first pull-up resistance and the first line resistance equals a sum of the second pull-up resistance and the second line resistance.

8. The gate line driver circuit of claim 7, wherein said first buffer is further configured to provide a first pull-down resistance to the first fan-out line when driving the first fan-out line with a trailing edge of the first gate signal pulse; and wherein a sum of the first pull-down resistance and the first line resistance equals a sum of the second pull-up resistance and the second line resistance.

9. A gate driver integrated circuit, which is disposed along a side portion of a liquid crystal display panel to drive the liquid crystal display panel, the circuit comprising:
a plurality of gate channels connected to gate lines formed on the liquid crystal display panel through fan-out lines, and outputting gate control signals to the fan-out lines in response to a start pulse signal and a clock signal,
wherein the fan-out lines have different resistance values from each other, and the plural gate channels delay the gate control signal for predetermined delay times that are set to be in inverse-proportion to the resistance values and output the gate control signals.

10. The circuit of claim 9, wherein the fan-out lines are arranged in parallel to each other, the fan-out lines disposed on both sides of the center fan-out line have resistance values symmetric to each other, the resistance values of the fan-out lines are gradually increased from the center to the both ends, and the delay times of the gate channels are gradually reduced from the center gate channel toward the gate channels on both ends.

11. The circuit of claim 9, wherein each of the plural gate channels includes:
a shift register receiving the start pulse signal and outputting a shift signal in response to the clock signal and a shift direction selection signal;
a level shifter converting a voltage level of the shift signal, and outputting the signal, the voltage level of which is converted, as a buffer control signal; and
an output buffer outputting one of the gate control signal in response to the buffer control signal,
wherein the output buffer has a current driving capacity that is in proportion to the resistance value of the corresponding fan-out lines, and the output delay time of the gate control signal is determined by the current driving capacity of the output buffer.

12. The circuit of claim 11, wherein the current driving capacities of the output buffers in the gate channels are increased gradually from the center gate channel toward the gate channels at both ends.

13. The circuit of claim 11, wherein the current driving capacity of the output buffer is in inverse-proportion to the resistance value of the output buffer, and the resistance values of the output buffers in the gate channels are reduced toward the gate channels at both ends based on the center gate channel.

14. The circuit of claim 13, wherein a difference between the resistance values of the output buffers of two neighboring gate channels is the same as a value that is calculated by dividing (2×a difference between the resistance values of the fan-out lines at the center and the fan-out line at one end portion) by the number of entire gate channels.

15. The circuit of claim 13, wherein a sum of the resistance values of the output buffers is the same as a sum of the resistance values of corresponding fan-out lines.

16. The circuit of claim 11, wherein the times of maintaining enabled states of the gate control signals output from the output buffers are the same as each other.
